(19) United States
(12) Patent Application Publication
(10) Pub. No.: US 2025/0077195 A1
(43) Pub. Date: Mar. 6, 2025

(54) SYSTEMS AND METHODS FOR AUTOMATIC INTEGRATION OF MODELS

(71) Applicant: STEERING SOLUTIONS IP HOLDING CORPORATION, SAGINAW, MI (US)

(72) Inventor: Owen K. TOSH, Saginaw, MI (US)

(21) Appl. No.: 18/644,910

(22) Filed: Apr. 24, 2024

Related U.S. Application Data
(60) Provisional application No. 63/579,581, filed on Aug. 30, 2023.

(51) Int. Cl. G06F 8/35; B62D 5/06; G06F 8/20

(52) U.S. Cl. CPC G06F 8/35; B62D 5/06; G06F 8/20

(57) ABSTRACT

A method for automatic integration of software models includes receiving at least one software component model, receiving at least one integration requirement, and receiving at least one partition block and at least one model reference block. The method also includes generating a system model based on the at least one software component model, the at least one integration requirement, the at least one partition block, and the at least one model reference block. The method also includes converting the system model to at least one programming language.

### CROSS-REFERENCES TO RELATED APPLICATIONS

This US Utility patent application claims priority to U.S. Provisional Patent Application Ser. No. 63/579,581, filed Aug. 30, 2023, which is incorporated herein by reference in its entirety.

### TECHNICAL FIELD

This disclosure relates to software model integration. And in particular to systems and methods for automatic integration of software models.

### BACKGROUND

A vehicle, such as a car, truck, sport utility vehicle, crossover, mini-van, marine craft, aircraft, all-terrain vehicle, recreational vehicle, or other suitable forms of transportation, typically includes various systems, such as a steering system, which may include an electronic power steering (EPS) system, a steer-by-wire (SbW) steering system, a hydraulic steering system, or other suitable steering system and/or other suitable systems (e.g., such as a braking system, propulsion system, and the like). Such systems of the vehicle typically controls various aspects of vehicle steering (e.g., including providing steering assist to an operator of the vehicle, controlling steerable wheels of the vehicle, and the like), vehicle propulsion, vehicle braking, and the like.

### SUMMARY

This disclosure relates generally to steering systems.

An aspect of the disclosed embodiments includes a method for automatic integration of software models. The method includes receiving at least one software component model, receiving at least one integration requirement, receiving at least one partition block, and receiving at least one model reference block. The method also includes generating a system model based on the at least one software component model, the at least one integration requirement, the at least one partition block, and the at least one model reference block. The method also includes converting the system model to at least one software model the represents the system model.

Another aspect of the disclosed embodiments includes a system for automatic integration of software models. The system includes a processor, and a memory including instructions that, when executed by the processor, cause the processor to: receive at least one software component model; receive at least one integration requirement; receive at least one partition block; receive at least one model reference block; generate a system model based on the at least one software component model, the at least one integration requirement, the at least one partition block, and the at least one model reference block; and convert the system model to at least one software model the represents the system model.

Another aspect of the disclosed embodiments includes an apparatus for automatic integration of software models. The apparatus includes a computer system configured to: receive at least one software component model; receive at least one integration requirement; receive at least one partition block; receive at least one model reference block; propagate integration parameters associated with the at least one partition block using the at least one model reference block; generate a system model based on the at least one software component model, the at least one integration requirement, the at least one partition block, and the integration parameters; and convert the system model to at least one software model the represents the system model.

These and other aspects of the present disclosure are disclosed in the following detailed description of the embodiments, the appended claims, and the accompanying figures.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 generally illustrates a vehicle according to the principles of the present disclosure.

FIG. 2 generally illustrates a controller according to the principles of the present disclosure.

FIGS. 3A and 3B generally illustrate a traditional approach for model integration.

FIGS. 4A and 4B generally illustrate an automatic model integration method according to the principles of the present disclosure.

FIGS. 5A-5C generally illustrates a block diagram of automatic model integration, according to the principles of the present disclosure.

FIG. 6 is a flow diagram generally illustrating an automatic model integration method according to the principles of the present disclosure.

FIG. 7 generally illustrates a computing device according to the principles of the present disclosure.

### DETAILED DESCRIPTION

The following discussion is directed to various embodiments of the disclosure. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

As described, a vehicle, such as a car, truck, sport utility vehicle, crossover, mini-van, marine craft, aircraft, all-terrain vehicle, recreational vehicle, or other suitable forms of transportation, typically includes various systems, such as a steering system, which may include an electronic power steering (EPS) system, a steer-by-wire (SbW) steering system, a hydraulic steering system, or other suitable steering system and/or other suitable systems (e.g., such as a braking system, propulsion system, and the like). Such systems of the vehicle typically controls various aspects of vehicle steering (e.g., including providing steering assist to an operator of the vehicle, controlling steerable wheels of the vehicle, and the like), vehicle propulsion, vehicle braking, and the like.

Typically, such system may rely on various software programs to provide control aspects of the various vehicle systems. Such software programs may include embedded software and/or other suitable software. Embedded software in the automotive industry has drastically increased in complexity, with modern programs consisting of hundreds of thousands of lines of code. In order to manage the complexity, software is broken into components that are later integrated together to form a complete software product.

However, software component integration may be relatively complicated and may require specialized knowledge and/or skills. For example, in addition to knowing where different components belong in the context of a software application, there is significant manual work involved in connecting inputs and outputs, routing special component requirements to the locations in the application where they can be fulfilled, and ensuring system resources are allocated properly.

Typical integration tools may be difficult to use and may be relatively limited in support of components, supporting components that include code (e.g., written in C or other suitable programming language) and configured files (e.g., written in extensible markup language (XML) or other suitable programming language).

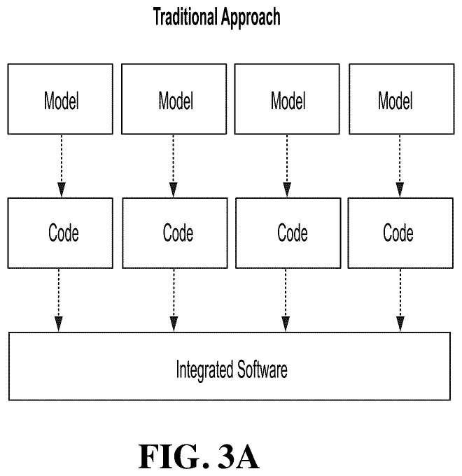

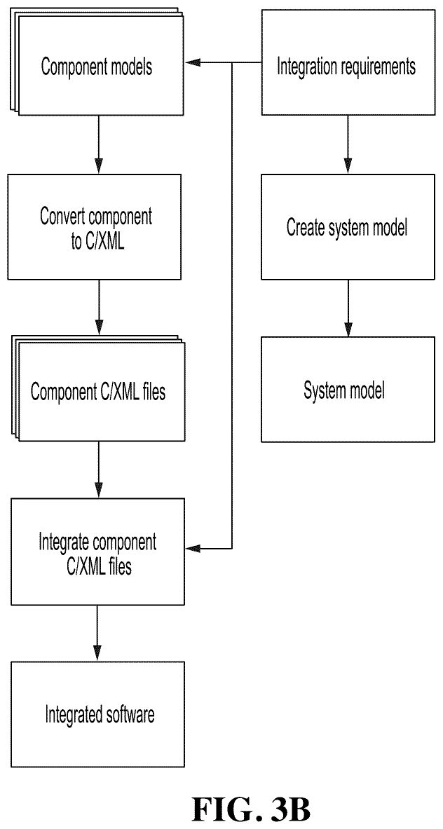

To compensate for the shortcomings of such integration tools, components may be created a models and auto-coding may be used to convert the models to C and/or XML, or other suitable programming languages. Such models include information that does not pertain to functionality of the associated components. FIGS. 3A and 3B generally illustrate traditional model integration. Such models necessarily contain information that does not pertain to functionality and modeling relatively large systems and testing component interactions may be increasingly difficult.

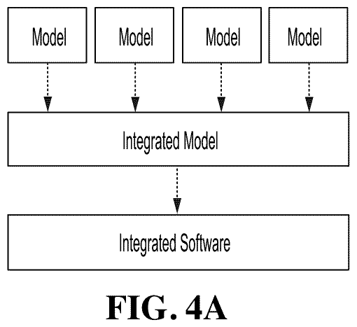

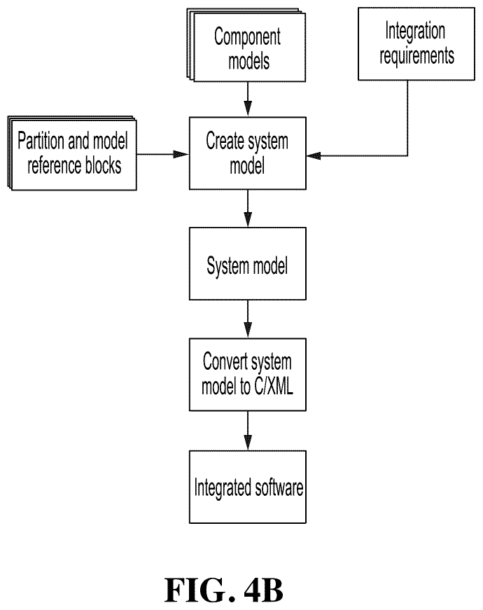

Accordingly, systems and methods, such as those described herein, configured to provide automatic integration of such models, may be desirable. In some embodiments, the systems and methods described herein may be configured to use a modeling interface layer to supplement various software architecture. The systems and methods described herein may be configured to provide integration of the component models, as is generally illustrated in FIGS. 4a and 4B, to create and auto-code a complete system.

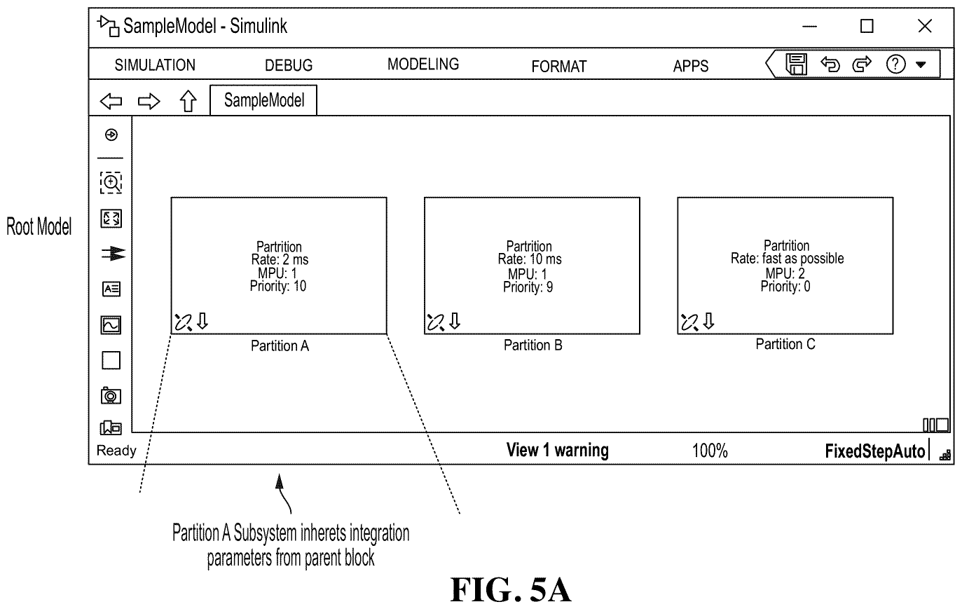

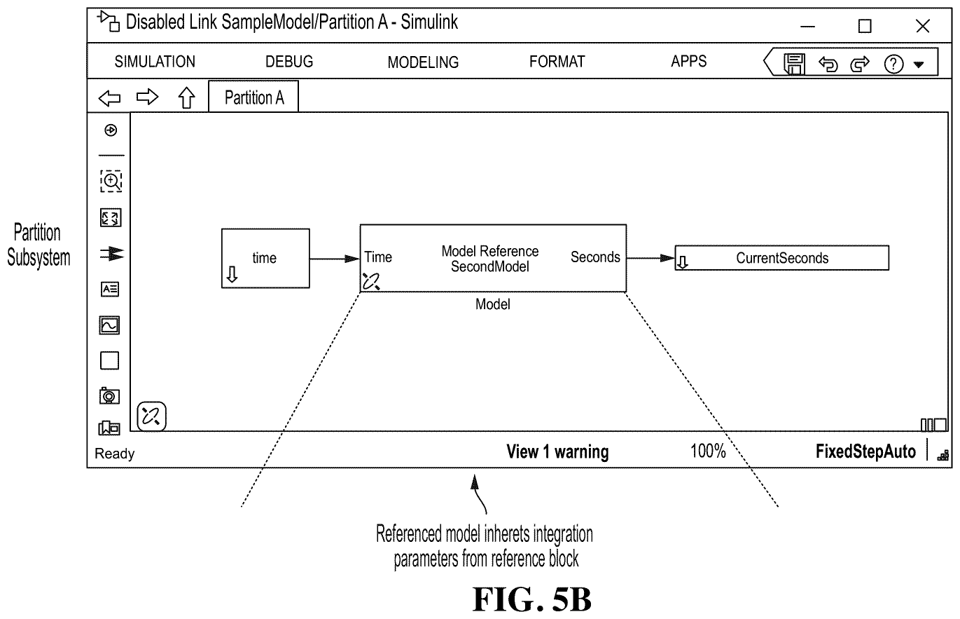

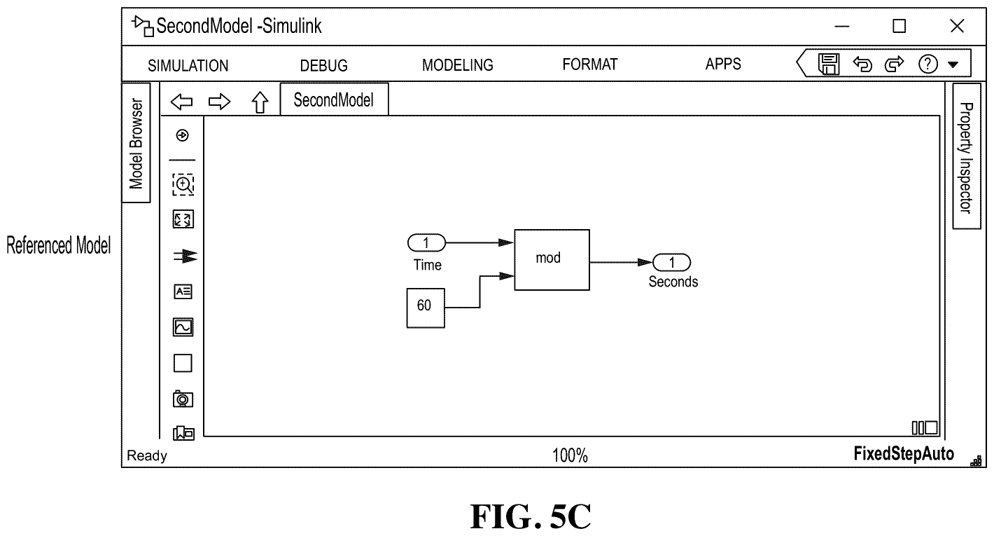

In some embodiments, the systems and methods described herein may be configured to use a library of modeling blocks, including at least a partition block, as is generally illustrated in FIGS. 5A-5C, used at the first layer of the model. Partition blocks may include special subsystem blocks, which can contain other blocks as children. Partition blocks contain information on how to integrate associated child blocks, including parameters for execution rate, MPU assignment, and task priority. Models may be built within parameter blocks, or models may be included using a model Reference block of the library, which may propagate the specific needs of the model to an associated parent (e.g., and may otherwise work the same way as a standard model reference block). All other blocks included within partition blocks may contain useful integration parameters (e.g., execution rate, MPU designation, priority, and/or the like).

The systems and methods described herein may be configured to provide modular model creation. The systems and methods described herein may be configured to provide components that are relatively simple (e.g., having fewer non-functional blocks required). The systems and methods described herein may be configured to provide a more portable solution (e.g., where components specify fewer integration parameters).

The systems and methods described herein may be configured to infer, after auto-coding the larger system, the integration parameters from the model. The systems and methods described herein may be configured to allow integration to be scripted (e.g., automatic) based on the model parameters.

In some embodiments, uses a modeling interface layer to supplement the typical software architecture, to remedy many of the previous concerns. For example, instead of auto-coding individual components and integrating the code/xml files, the systems and methods described herein may be configured to use the modeling interface layer to integrate the models to create a complete system at the modeling level. The systems and methods described herein may be configured to may then auto code the entire system.

In some embodiments, the systems and methods described herein may be configured to provide component models that are greatly simplified compared to a traditional approach. Components may be designed without specific integration information, like execution rates. Instead, the functionality of the component may be used, improving clarity (e.g., by removing non-functional integration blocks). Additionally, or alternatively, because components may be designed without concern for execution rates, memory protection unit (MPU) assignment, or most other integration concerns, components are more portable (e.g., that is, the components can be moved from one partition to another, even at a different execution rate, with no change to the component model).

In some embodiments, the systems and methods described herein may be configured to use the custom blocks, such that the information used for integration is inherent in the model. The systems and methods described herein may be configured to, after auto-coding the system, access, using the model interface layer, the information within the blocks to assign the generated code to appropriate locations and configure the lower-level software (e.g., RTE, operating system, communication channels).

In some embodiments, the systems and methods described herein may be configured to integrate component models and/or improve representation of the final product of the model. The systems and methods described herein may be configured to, because the system is coded from the integrated model, include information like execution rates into the model to automatically integrate the generated code.

In some embodiments, the systems and methods described herein may be configured to provide automatic integration of software models. The systems and methods described herein may be configured to receive at least one software component model. The systems and methods described herein may be configured to receive at least one integration requirement. The systems and methods described herein may be configured to receive at least one partition block. The systems and methods described herein may be configured to receive at least one mode reference block.

The systems and methods described herein may be configured to generate a system model based on the at least one software component model, the at least one integration requirement, the at least one partition, and the at least one model reference block. The systems and methods described herein may be configured to convert the system model to at least one programming language.

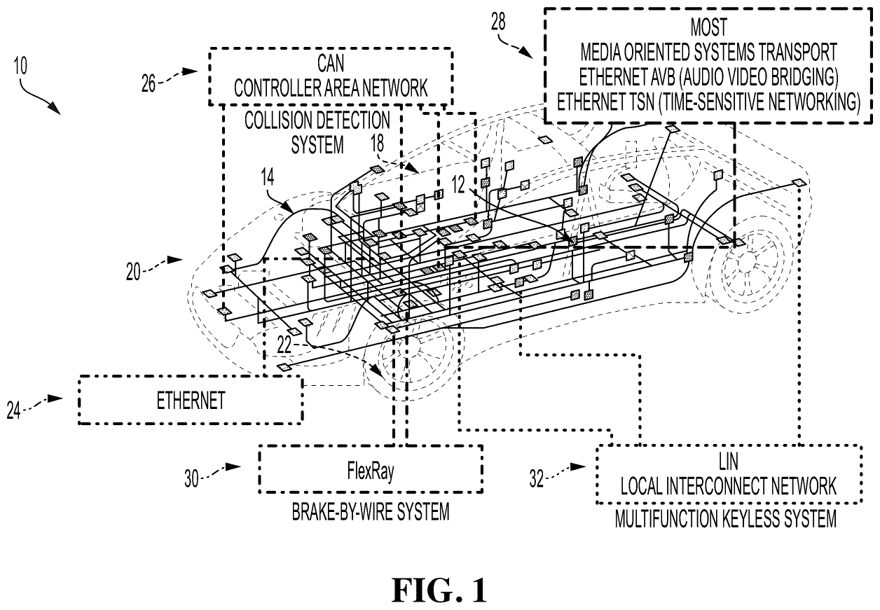

FIG. 1 generally illustrates a vehicle 10 according to the principles of the present disclosure. The vehicle 10 may include any suitable vehicle, such as a car, a truck, a sport utility vehicle, a mini-van, a crossover, any other passenger vehicle, any suitable commercial vehicle, or any other suitable vehicle. While the vehicle 10 is illustrated as a passenger vehicle having wheels and for use on roads, the principles of the present disclosure may apply to other vehicles, such as planes, boats, trains, drones, or other suitable vehicles

The vehicle 10 includes a vehicle body 12 and a hood 14. A passenger compartment 18 is at least partially defined by the vehicle body 12. Another portion of the vehicle body 12 defines an engine compartment 20. The hood 14 may be moveably attached to a portion of the vehicle body 12, such that the hood 14 provides access to the engine compartment 20 when the hood 14 is in a first or open position and the hood 14 covers the engine compartment 20 when the hood 14 is in a second or closed position. In some embodiments, the engine compartment 20 may be disposed on rearward portion of the vehicle 10 than is generally illustrated.

The passenger compartment 18 may be disposed rearward of the engine compartment 20, but may be disposed forward of the engine compartment 20 in embodiments where the engine compartment 20 is disposed on the rearward portion of the vehicle 10. The vehicle 10 may include any suitable propulsion system including an internal combustion engine, one or more electric motors (e.g., an electric vehicle), one or more fuel cells, a hybrid (e.g., a hybrid vehicle) propulsion system comprising a combination of an internal combustion engine, one or more electric motors, and/or any other suitable propulsion system.

In some embodiments, the vehicle 10 may include a petrol or gasoline fuel engine, such as a spark ignition engine. In some embodiments, the vehicle 10 may include a diesel fuel engine, such as a compression ignition engine. The engine compartment 20 houses and/or encloses at least some components of the propulsion system of the vehicle 10. Additionally, or alternatively, propulsion controls, such as an accelerator actuator (e.g., an accelerator pedal), a brake actuator (e.g., a brake pedal), a handwheel, and other such components are disposed in the passenger compartment 18 of the vehicle 10. The propulsion controls may be actuated or controlled by a operator of the vehicle 10 and may be directly connected to corresponding components of the propulsion system, such as a throttle, a brake, a vehicle axle, a vehicle transmission, and the like, respectively. In some embodiments, the propulsion controls may communicate signals to a vehicle computer (e.g., drive by wire) which in turn may control the corresponding propulsion component of the propulsion system. As such, in some embodiments, the vehicle 10 may be an autonomous vehicle.

In some embodiments, the vehicle 10 includes a transmission in communication with a crankshaft via a flywheel or clutch or fluid coupling. In some embodiments, the transmission includes a manual transmission. In some embodiments, the transmission includes an automatic transmission. The vehicle 10 may include one or more pistons, in the case of an internal combustion engine or a hybrid vehicle, which cooperatively operate with the crankshaft to generate force, which is translated through the transmission to one or more axles, which turns wheels 22. When the vehicle 10 includes one or more electric motors, a vehicle battery, and/or fuel cell provides energy to the electric motors to turn the wheels 22.

The vehicle 10 may include automatic vehicle propulsion systems, such as a cruise control, an adaptive cruise control, automatic braking control, other automatic vehicle propulsion systems, or a combination thereof. The vehicle 10 may be an autonomous or semi-autonomous vehicle, or other suitable type of vehicle. The vehicle 10 may include additional or fewer features than those generally illustrated and/or disclosed herein.

In some embodiments, the vehicle 10 may include an Ethernet component 24, a controller area network (CAN) bus 26, a media oriented systems transport component (MOST) 28, a FlexRay component 30 (e.g., brake-by-wire system, and the like), and a local interconnect network component (LIN) 32. The vehicle 10 may use the CAN bus 26, the MOST 28, the FlexRay Component 30, the LIN 32, other suitable networks or communication systems, or a combination thereof to communicate various information from, for example, sensors within or external to the vehicle, to, for example, various processors or controllers within or external to the vehicle. The vehicle 10 may include additional or fewer features than those generally illustrated and/or disclosed herein.

In some embodiments, the vehicle 10 may include a steering system, such as an EPS system, a steering-by-wire steering system (e.g., which may include or communicate with one or more controllers that control components of the steering system without the use of mechanical connection between the handwheel and wheels 22 of the vehicle 10), a hydraulic steering system (e.g., which may include a magnetic actuator incorporated into a valve assembly of the hydraulic steering system), or other suitable steering system.

The steering system may include an open-loop feedback control system or mechanism, a closed-loop feedback control system or mechanism, or combination thereof. The steering system may be configured to receive various inputs, including, but not limited to, a handwheel position, an input torque, one or more roadwheel positions, other suitable inputs or information, or a combination thereof.

Additionally, or alternatively, the inputs may include a handwheel torque, a handwheel angle, a motor velocity, a vehicle speed, an estimated motor torque command, other suitable input, or a combination thereof. The steering system may be configured to provide steering function and/or control to the vehicle 10. For example, the steering system may generate an assist torque based on the various inputs. The steering system may be configured to selectively control a motor of the steering system using the assist torque to provide steering assist to the operator of the vehicle 10.

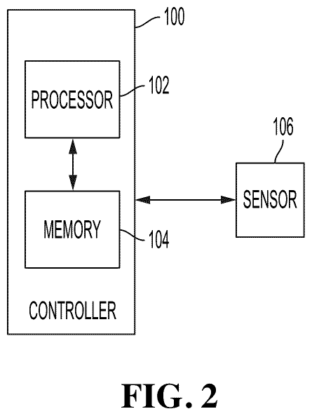

In some embodiments, the vehicle 10 may include a controller, such as controller 100, as is generally illustrated in FIG. 2. The controller 100 may include any suitable controller, such as an electronic control unit or other suitable controller. The controller 100 may be configured to control, for example, the various functions of the steering system and/or various functions of the vehicle 10. The controller 100 may include a processor 102 and a memory 104. The processor 102 may include any suitable processor, such as those described herein. Additionally, or alternatively, the controller 100 may include any suitable number of processors, in addition to or other than the processor 102. The memory 104 may comprise a single disk or a plurality of disks (e.g., hard drives), and includes a storage management module that manages one or more partitions within the memory 104. In some embodiments, memory 104 may include flash memory, semiconductor (solid state) memory or the like. The memory 104 may include Random Access Memory (RAM), a Read-Only Memory (ROM), or a combination thereof. The memory 104 may include instructions that, when executed by the processor 102, cause the processor 102 to, at least, control various aspects of the vehicle 10.

The controller 100 may receive one or more signals from various measurement devices or sensors 106 indicating sensed or measured characteristics of the vehicle 10. The sensors 106 may include any suitable sensors, measurement devices, and/or other suitable mechanisms. For example, the sensors 106 may include one or more torque sensors or devices, one or more handwheel position sensors or devices, one or more motor position sensor or devices, one or more position sensors or devices, one or more radar sensors or devices, one or more lidar sensors or devices, one or more sonar sensors or devices, one or more image capturing sensors or devices, other suitable sensors or devices, or a combination thereof. The one or more signals may indicate a handwheel torque, a handwheel angle, a motor velocity, a vehicle speed, other suitable information, or a combination thereof.

In some embodiments, the controller 100 may be configured to provide automatic integration of software models. The controller 100 may receive at least one software component model. The controller 100 may receive at least one integration requirement. The controller 100 may receive at least one partition. The controller 100 may receive at least one model reference block.

The controller 100 may generate a system model based on the at least one software component model, the at least one integration requirement, the at least one partition, and the at least one model reference block. The controller 100 may convert the system model to at least one programming language.

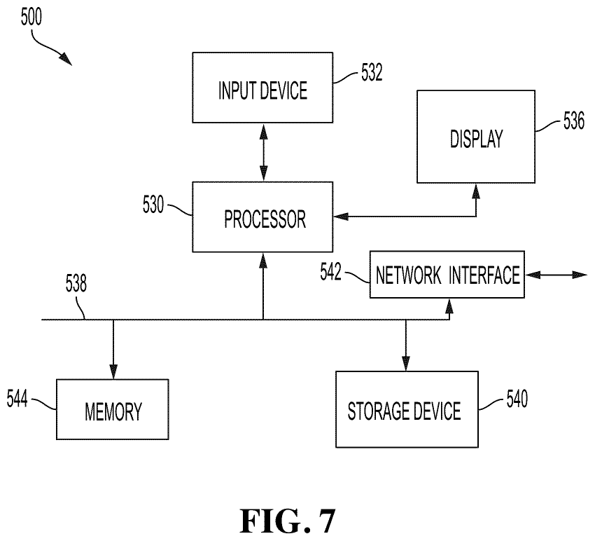

In some embodiments, a computing device, such a computing device 500, as is generally illustrated in FIG. 7, may be configured to provide automatic model integration. The computing device 500 may include any suitable computing device, such as a mobile computing device, a desktop computing device, a laptop computing device, a server computing device, other suitable computing device, or a combination thereof.

The computing device 500 may include a processor 530 configured to control the overall operation of computing device 500. The processor 530 may include any suitable processor, such as those described herein. The computing device 500 may also include a user input device 532 that is configured to receive input from a user of the computing device 500 and to communicate signals representing the input received from the user to the processor 530. For example, the user input device 532 may include a button, keypad, dial, touch screen, audio input interface, visual/image capture input interface, input in the form of sensor data, etc.

The computing device 500 may include a display 536 that may be controlled by the processor 530 to display information to the user. A data bus 538 may be configured to facilitate data transfer between, at least, a storage device 540 and the processor 530. The computing device 500 may also include a network interface 542 configured to couple or connect the computing device 500 to various other computing devices or network devices via a network connection, such as a wired or wireless connection. In some embodiments, the network interface 542 includes a wireless transceiver.

The storage device 540 may comprise a single disk or a plurality of disks (e.g., hard drives), one or more solid-state drives, one or more hybrid hard drives, and the like. The storage device 540 may include a storage management module that manages one or more partitions within the storage device 540. In some embodiments, storage device 540 may include flash memory, semiconductor (solid state) memory or the like. The computing device 500 may also include a memory 544. The memory 544 may include Random Access Memory (RAM), a Read-Only Memory (ROM), or a combination thereof. The memory 544 may store programs, utilities, or processes to be executed in by the processor 530. The memory 544 may provide volatile data storage, and stores instructions related to the operation of the computing device 500.

In some embodiments, the computing device 500, using the processor 530, may be configured to execute instructions stored on the memory 544 to, at least, perform the systems and methods described herein. For example, the computing device 500 may receive at least one software component model. The computing device 500 may receive at least one integration requirement. The computing device 500 may receive at least one partition block. The computing device 500 may receive at least one model reference block. The computing device 500 may generate a system model based on the at least one software component model, the at least one integration requirement, the at least one partition block, and the at least one model reference block. The computing device 500 may convert the system model to at least one software model the represents the system model.

In some embodiments, the controller 100 may receive, from the computing device 500, the software model. The controller 100 may control various aspects of the vehicle 10 using the software model.

In some embodiments, the controller 100 and/or the computing device 500 may perform the methods described herein. However, the methods described herein as performed by the controller 100 and/or the computing device 500 are not meant to be limiting, and any type of software executed on a controller or processor can perform the methods described herein without departing from the scope of this disclosure. For example, a controller, such as a processor executing software within a computing device, can perform the methods described herein.

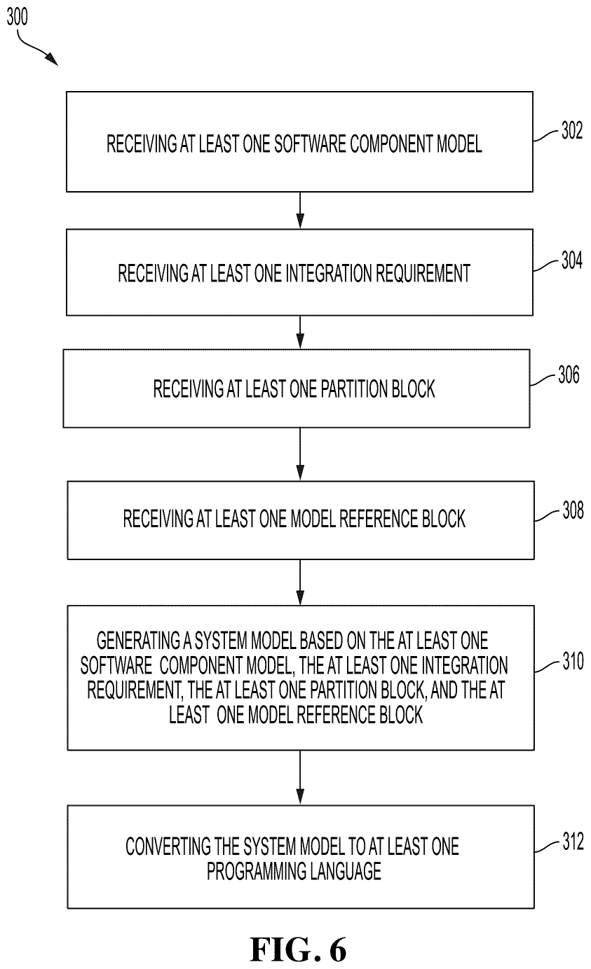

FIG. 6 is a flow diagram generally illustrating an automatic model integration method 300 according to the principles of the present disclosure. At 302, the method 300 receives at least one software component model. For example, the controller 100 may receive the at least one software component model.

At 304, the method 300 receives at least one integration requirement. For example, the controller 100 may receive the at least one integration requirement.

At 306, the method 300 receives at least one partition block. For example, the controller 100 may receive the at least one partition block.

At 308, the method 300 receives at least one model reference block. For example, the controller 100 may receive the at least one model reference block.

At 308, the method 300 generates a system model based on the at least one software component model, the at least one integration requirement, the at least one partition block, and the at least one model reference block. For example, the controller 100 may generate the system model based on the at least one software component model, the at least one integration requirement, the at least one partition, and the at least one model reference block.

At 310, the method 300 converts the system model to at least one programming language. For example, the controller 100 may convert the system model to at least one programming language.

In some embodiments, a method for automatic integration of software models includes receiving at least one software component model, receiving at least one integration requirement, and receiving at least one partition and model reference block. The method also includes generating a system model based on the at least one software component model, the at least one integration requirement, and the at least one partition and model reference block. The method also includes converting the system model to at least one programming language.

In some embodiments, the system model is associated with a steering system of a vehicle. In some embodiments, the steering system includes an electronic power steering system. In some embodiments, the steering system includes a steer-by-wire steering system. In some embodiments, the steering system includes a hydraulic steering system.

In some embodiments, a system for automatic integration of software models includes a processor, and a memory. The memory includes instructions that, when executed by the processor, cause the processor to: receive at least one software component model; receive at least one integration requirement; receive at least one partition and model reference block; generate a system model based on the at least one software component model, the at least one integration requirement, and the at least one partition and model reference block; and convert the system model to at least one programming language.

In some embodiments, the system model is associated with a steering system of a vehicle. In some embodiments, the steering system includes an electronic power steering system. In some embodiments, the steering system includes a steer-by-wire steering system. In some embodiments, the steering system includes a hydraulic steering system.

In some embodiments, a method for automatic integration of software models includes receiving at least one software component model, receiving at least one integration requirement, receiving at least one partition block, and receiving at least one model reference block. The method also includes generating a system model based on the at least one software component model, the at least one integration requirement, the at least one partition block, and the at least one model reference block. The method also includes converting the system model to at least one software model the represents the system model.

In some embodiments, the system model is associated with a steering system of a vehicle. In some embodiments, the steering system includes an electronic power steering system. In some embodiments, the steering system includes a steer-by-wire steering system. In some embodiments, the steering system includes a hydraulic steering system. In some embodiments, the at least one integration requirement includes an execution rate. In some embodiments, the at least one integration requirement includes a memory protection unit assignment. In some embodiments, the at least one integration requirement includes a priority. In some embodiments, the at least one model reference block is configured to propagate integration parameters associated with the at least one partition block. In some embodiments, the system model integrates a model, associated with the at least one software component model, and at least one other model. In some embodiments, the at least one software model is configured to model aspects of at least one vehicle component.

In some embodiments, a system for automatic integration of software models includes a processor, and a memory including instructions that, when executed by the processor, cause the processor to: receive at least one software component model; receive at least one integration requirement; receive at least one partition block; receive at least one model reference block; generate a system model based on the at least one software component model, the at least one integration requirement, the at least one partition block, and the at least one model reference block; and convert the system model to at least one software model the represents the system model.

In some embodiments, the system model is associated with a steering system of a vehicle. In some embodiments, the at least one integration requirement includes an execution rate. In some embodiments, the at least one integration requirement includes a memory protection unit assignment. In some embodiments, the at least one integration requirement includes a priority. In some embodiments, the at least one model reference block is configured to propagate integration parameters associated with the at least one partition block. In some embodiments, the system model integrates a model, associated with the at least one software component model, and at least one other model. In some embodiments, the at least one software model is configured to model aspects of at least one vehicle component.

In some embodiments, an apparatus for automatic integration of software models includes a computer system configured to: receive at least one software component model; receive at least one integration requirement; receive at least one partition block; receive at least one model reference block; propagate integration parameters associated with the at least one partition block using the at least one model reference block; generate a system model based on the at least one software component model, the at least one integration requirement, the at least one partition block, and the integration parameters; and convert the system model to at least one software model the represents the system model.

The above discussion is meant to be illustrative of the principles and various embodiments of the present disclosure. Numerous variations and modifications will become apparent to those skilled in the art once the above disclosure is fully appreciated. It is intended that the following claims be interpreted to embrace all such variations and modifications.

The word “example” is used herein to mean serving as an example, instance, or illustration. Any aspect or design described herein as “example” is not necessarily to be construed as preferred or advantageous over other aspects or designs. Rather, use of the word “example” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an implementation” or “one implementation” throughout is not intended to mean the same embodiment or implementation unless described as such.

Implementations the systems, algorithms, methods, instructions, etc., described herein can be realized in hardware, software, or any combination thereof. The hardware can include, for example, computers, intellectual property (IP) cores, application-specific integrated circuits (ASICs), programmable logic arrays, optical processors, programmable logic controllers, microcode, microcontrollers, servers, microprocessors, digital signal processors, or any other suitable circuit. In the claims, the term “processor” should be understood as encompassing any of the foregoing hardware, either singly or in combination. The terms “signal” and “data” are used interchangeably.

As used herein, the term module can include a packaged functional hardware unit designed for use with other components, a set of instructions executable by a controller (e.g., a processor executing software or firmware), processing circuitry configured to perform a particular function, and a self-contained hardware or software component that interfaces with a larger system. For example, a module can include an application specific integrated circuit (ASIC), a Field Programmable Gate Array (FPGA), a circuit, digital logic circuit, an analog circuit, a combination of discrete circuits, gates, and other types of hardware or combination thereof. In other embodiments, a module can include memory that stores instructions executable by a controller to implement a feature of the module.

Further, in one aspect, for example, systems described herein can be implemented using a general-purpose computer or general-purpose processor with a computer program that, when executed, carries out any of the respective methods, algorithms, and/or instructions described herein. In addition, or alternatively, for example, a special purpose computer/processor can be utilized which can contain other hardware for carrying out any of the methods, algorithms, or instructions described herein.

Further, all or a portion of implementations of the present disclosure can take the form of a computer program product accessible from, for example, a computer-usable or computer-readable medium. A computer-usable or computer-readable medium can be any device that can, for example, tangibly contain, store, communicate, or transport the program for use by or in connection with any processor. The medium can be, for example, an electronic, magnetic, optical, electromagnetic, or a semiconductor device. Other suitable mediums are also available.

The above-described embodiments, implementations, and aspects have been described in order to allow easy understanding of the present disclosure and do not limit the present disclosure. On the contrary, the disclosure is intended to cover various modifications and equivalent arrangements included within the scope of the appended claims, which scope is to be accorded the broadest interpretation so as to encompass all such modifications and equivalent structure as is permitted under the law.

What is claimed is:

1. A method for automatic integration of software models, the method comprising:
receiving at least one software component model;
receiving at least one integration requirement;
receiving at least one partition block;
receiving at least one model reference block;
generating a system model based on the at least one software component model, the at least one integration requirement, the at least one partition block, and the at least one model reference block; and
converting the system model to at least one software model the represents the system model.

2. The method of claim 1, wherein the system model is associated with a steering system of a vehicle.

3. The method of claim 2, wherein the steering system includes an electronic power steering system.

4. The method of claim 2, wherein the steering system includes a steer-by-wire steering system.

5. The method of claim 2, wherein the steering system includes a hydraulic steering system.

6. The method of claim 1, wherein the at least one integration requirement includes an execution rate.

7. The method of claim 1, wherein the at least one integration requirement includes a memory protection unit assignment.

8. The method of claim 1, wherein the at least one integration requirement includes a priority.

9. The method of claim 1, wherein the at least one model reference block is configured to propagate integration parameters associated with the at least one partition block.

10. The method of claim 1, wherein the system model integrates a model, associated with the at least one software component model, and at least one other model.

11. The method of claim 1, wherein the at least one software model is configured to model aspects of at least one vehicle component.

12. A system for automatic integration of software models, the system comprising:
a processor; and
a memory including instructions that, when executed by the processor, cause the processor to:
receive at least one software component model;
receive at least one integration requirement;
receive at least one partition block;
receive at least one model reference block;
generate a system model based on the at least one software component model, the at least one integration requirement, the at least one partition block, and the at least one model reference block; and
convert the system model to at least one software model the represents the system model.

13. The system of claim 12, wherein the system model is associated with a steering system of a vehicle.

14. The system of claim 12, wherein the at least one integration requirement includes an execution rate.

15. The system of claim 12, wherein the at least one integration requirement includes a memory protection unit assignment.

16. The system of claim 12, wherein the at least one integration requirement includes a priority.

17. The system of claim 12, wherein the at least one model reference block is configured to propagate integration parameters associated with the at least one partition block.

18. The system of claim 12, wherein the system model integrates a model, associated with the at least one software component model, and at least one other model.

19. The system of claim 12, wherein the at least one software model is configured to model aspects of at least one vehicle component.

20. An apparatus for automatic integration of software models, the apparatus comprising:
a computer system configured to:
receive at least one software component model;
receive at least one integration requirement;
receive at least one partition block;
receive at least one model reference block;
propagate integration parameters associated with the at least one partition block using the at least one model reference block;
generate a system model based on the at least one software component model, the at least one integration requirement, the at least one partition block, and the integration parameters; and
convert the system model to at least one software model the represents the system model.
